(19) United States
(12) Patent Application Publication
(10) Pub. No.: US 2013/0054464 A1
(43) Pub. Date: Feb. 28, 2013

(54) TERMINAL, SYSTEM, AND METHOD FOR AUTHORIZING PAYMENT

(71) Applicant: Moon Sup LEE, Seoul (KR)

(72) Inventor: Moon Sup LEE, Seoul (KR)

(73) Assignee: PANTECH CO., LTD., Seoul (KR)

(21) Appl. No.: 13/590,971

(22) Filed: Aug. 21, 2012

(30) Foreign Application Priority Data
Aug. 26, 2011 (KR) 10-2011-0085882

(51) Int. Cl. G06Q 20/40; H04B 5/00; G06Q 20/32; H04B 7/00

(52) U.S. Cl. 705/44; 455/41.2; 455/41.1

(57) ABSTRACT

A terminal, includes: a communication; a short range communication unit to communicate via short range communication to a second terminal; and a processor to parse data for either communication via the network or short range communication, wherein in response to the terminal and the second terminal being within a threshold distance from each other, the short range communication unit communicates data to the second terminal, and if the terminal is unrecognized by the second terminal, the communication unit communicates certification via the network. A method for authorizing a terminal, includes: establishing short range communication from the terminal to a second terminal in response to the terminal and the second terminal being within a threshold distance from each other; parsing data to be communicated; and if the terminal is unrecognized by the second terminal, communicating a certification via the network.

### CROSS-REFERENCE TO RELATED APPLICATION

This application claims priority from and the benefit under 35 U.S.C. §119(a) of Korean Patent Application No. 10-2011-0085882, filed on Aug. 26, 2011, which is incorporated by reference for all purposes as if fully set forth herein.

### BACKGROUND

1. Field

Exemplary embodiments of the present invention relate to a terminal, system and method for authorizing payment.

2. Discussion of the Background

A near field communication (NFC) technique may be used along with a cell is phone in order to communicate with a bank or payment terminal.

Korean Patent Publication No. 10-2009-0014419, entitled “System and Method for Moving Affiliated Store using Short Distance Communication and Program Recording Medium”, discloses a method for processing payment through a wireless terminal without using a separate payment terminal, by registering a wireless terminal possessed by an employee of an affiliated store as a wireless payment terminal of a moving affiliated store.

This payment system uses NFC, and allows a user to make a payment if a cellular phone terminal approaches a payment terminal. In other words, if a terminal capable of making payments directly approaches or is near to the payment terminal, the payment is performed, due in part to the proximity of the terminals. If a terminal without payment authority requests to make a payment, the above disclosed scenario may not allow for a payment to be performed.

### SUMMARY

Exemplary embodiments of the present invention provide a terminal, system and method for authorizing payment. Specifically, exemplary embodiments relate to providing an authorization of payment over a secure short range communication technique, such as near field communication (NFC) or RFID, while adding to the security authorization obtained over another communication technique.

Additional features of the invention will be set forth in the description which follows, and in part will be apparent from the description, or may be learned by practice of the invention.

An exemplary embodiment of the present invention discloses a terminal, including: a communication unit to communicate via a network; a short range communication unit to communicate via short range communication to a second terminal; and a processor to parse data for either communication via the network or short range communication.

An exemplary embodiment of the present invention discloses a method for authorizing a terminal, comprising: establishing short range communication from the terminal to a second terminal in response to the terminal and the second terminal being within a threshold distance from each other; parsing data to be communicated via short range communication or via the network; and if the terminal is unrecognized by the second terminal, communicating a certification via the network.

An exemplary embodiment of the present invention discloses a system to authorize a payment using a near field communication (NFC), including: a payment authority requesting terminal to request a payment authority using a NFC connection; a payment terminal to receive the payment authority request and payment authority information; a payment holding authority terminal corresponding to the payment authority information to provide an authority for the payment; and a server to receive the authority for the payment and to authorize the payment terminal to accept the payment from the payment authority requesting terminal.

An exemplary embodiment of the present invention discloses a payment authority requesting terminal, including: a wireless communication unit to communicate via a payment server; a near field communication unit to communicate via short range communication to a second terminal; a payment authority management layer to determine whether to use an internal payment authority or to generate a request for payment; and a processor to parse data for either communication via the network or short range communication, wherein in response to the terminal and the second terminal being within a threshold distance from each other, the near field communication unit communicates the request for payment to the second terminal.

An exemplary embodiment of the present invention discloses a payment authority holding terminal, including: a wireless communication unit to communicate via a payment server; a near field communication unit to communicate via short range communication; and a payment authority management layer to generate payment authority according to authority information; and a processor to parse data for either communication via the payment server or short range communication, wherein in response to receiving a payment request, the payment authority management layer generates payment authority and the wireless communication unit transmits the payment authority to the payment server, and the payment sever approves the payment request to a second terminal according to the payment authority.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a schematic view illustrating a near field payment transaction system according to an exemplary embodiment of the present invention.

FIG. 2 is a schematic view illustrating a payment authority requesting terminal and a payment authority holding terminal according to an exemplary embodiment of the present invention.

FIG. 3 is a schematic view illustrating payment authority information according to an exemplary embodiment of the present invention.

FIG. 4 is a flowchart for illustrating a method for authorizing payment according to an exemplary embodiment of the present invention.

FIG. 5 is a flowchart for illustrating a method for authorizing payment with a payment authority holding terminal according to an exemplary embodiment of the present invention.

FIG. 6 is a flowchart for illustrating a method for providing results of a payment according to an exemplary embodiment of the present invention.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION OF THE ILLUSTRATED EMBODIMENTS

Exemplary embodiments now will be described more fully hereinafter with reference to the accompanying drawings, in which exemplary embodiments are shown. The present disclosure may, however, be embodied in many different forms and should not be construed as limited to the exemplary embodiments set forth therein. Rather, these exemplary embodiments are provided so that the present disclosure will be thorough and complete, and will fully convey the scope of the present disclosure to those skilled in the art. In the description, details of well-known features and techniques may be omitted to avoid unnecessarily obscuring the presented embodiments.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly io formal sense unless expressly so defined herein.

It will be understood that for the purposes of this disclosure, “at least one of X, Y, and Z” can be construed as X only, Y only, Z only, or any combination of two or more items X, Y, and Z (e.g., XYZ, XYY, YZ, ZZ).

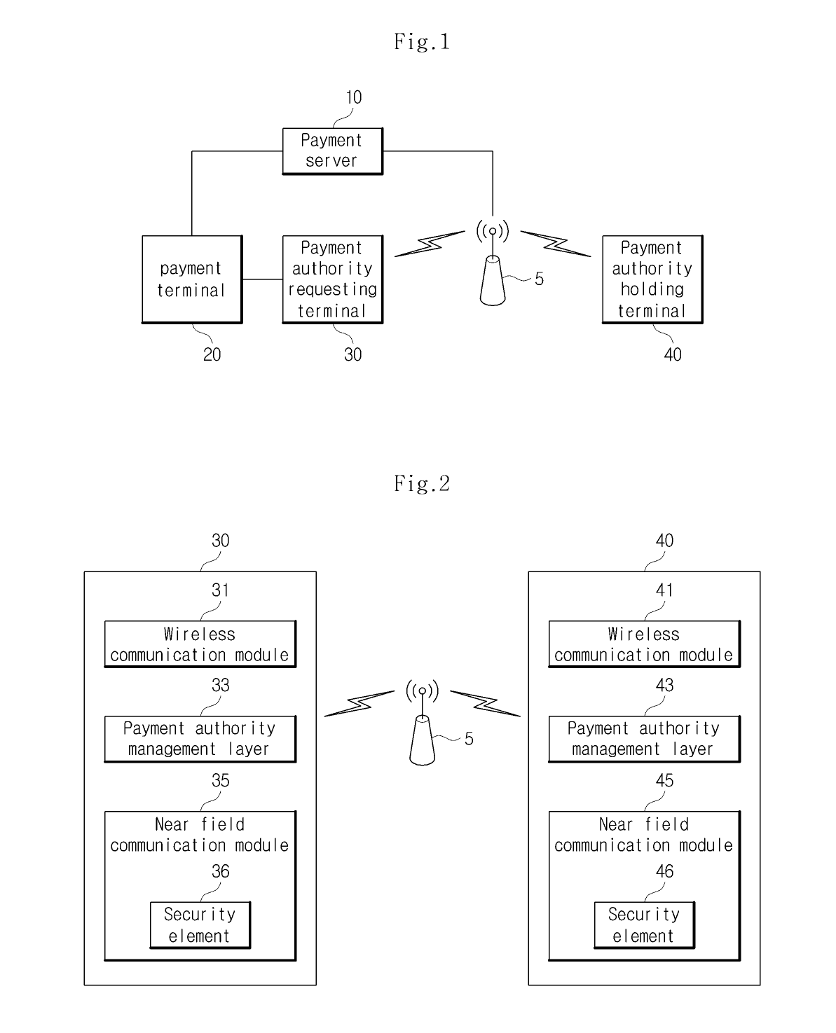

FIG. 1 is a schematic view illustrating a near field payment transaction system according to an exemplary embodiment of the present invention.

Referring to FIG. 1, a near field payment transaction system includes a payment server 10, a payment terminal 20, a payment authority requesting terminal 30, and a payment authority holding terminal 40.

The payment terminal 20 performs payment through certification using a payment server 10. The payment terminal 20 may approve a payment or receive approval for a payment, for example by contacting the server 10 or other terminal, and may be referred to as a payment approving terminal; however, aspects need not be limited thereto.

The payment authority requesting terminal 30 requests the payment terminal 20 that a payment be made. This request may be accomplished with NFC. The payment authority requesting terminal 30 may also receive payment information and a payment authority information request signal from the payment terminal 20, request the transfer of payment authority to a payment authority holding terminal 40 with payment authority. The payment authority requesting terminal 30 may communicate with the payment authority holding terminal 40 over a communication network 5. The payment authority requesting terminal 30 may perform this in order to make a payment upon authority from the payment authority holding terminal 40 while in NFC range with a payment terminal 20.

The payment authority holding terminal 40 checks the request for payment authority received over the communication network 5, and determines if the payment authority requesting terminal 30 has payment authority, and requests that the payment server 10 to allow payment from the payment authority requesting terminal 30.

The payment server 10 checks and approves the request for payment authority from either the payment terminal 20 or the payment authority holding terminal 40 (over a communication network 5), and transmits acceptance of the payment authority to the requesting source terminal, i.e. either the payment terminal 20 or the payment authority holding terminal 40.

FIG. 2 is a schematic view illustrating a payment authority requesting terminal and a payment authority holding terminal according to an exemplary embodiment of the present invention.

Referring to FIG. 2, the payment authority requesting terminal 30 and the payment authority holding terminal 40 may have similar components. The payment authority requesting terminal 30 includes a wireless communication module 31, a payment authority management layer 33, and a NFC module 35 with a security element 36. Similarly, the payment authority holding terminal 40 includes a wireless communication module 41, a payment authority management layer 43, and a NFC module 45 with a security element 46.

The payment authority management layer 33 and the payment authority management layer 43 may be implemented on or as a processor.

The wireless communication modules 31 and 41 may be physical elements that allow the exchange of payment information with the payment terminal 20 and the payment authority holding terminal 40, if the payment authority requesting terminal 30 is within NFC range with a payment terminal 20.

The payment authority management layers 33 and 43 are layers that determine whether payment authority is used in a given transaction. The payment authority management layers 33 and 43 determine whether to use an internal payment authority or to request and use authority information from a third party if requesting the approval of payment information. If requesting authority of a third party, the payment authority management layers 33 and 43 process and generate the request.

The NFC modules 35 and 45 allow communication between a payment terminal 20 and a payment authority requesting terminal 30 with NFC. The NFC modules 35 and 45 may communicate using NFC. Alternatively or in addition, the terminals may incorporate an RFID communication. The NFC modules 35 and 45 respectively include security elements 36 and 46.

The security elements 36 and 46 contain authority information associated with payment. In other words, payment approval may be requested via NFC between two terminals based on the authority information contained within the security elements 36 and 46.

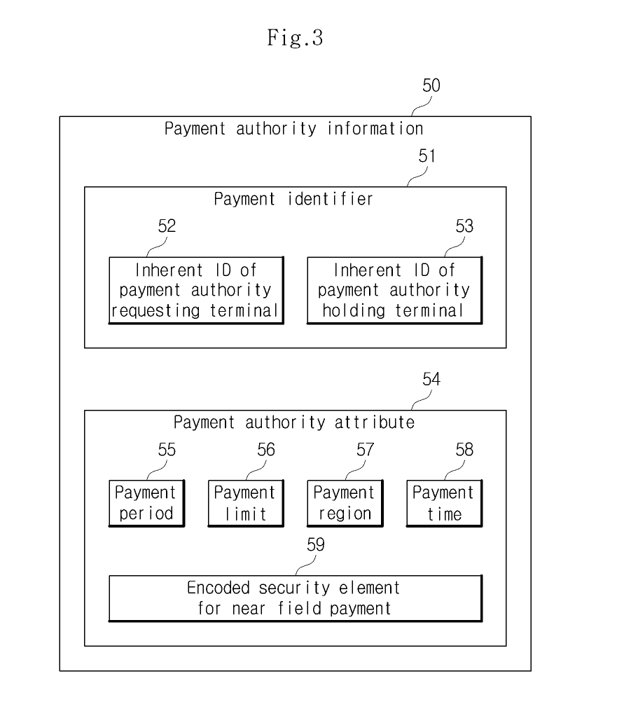

FIG. 3 is a schematic view illustrating payment authority information according to an exemplary embodiment of the present invention.

Referring to FIG. 3, the payment authority information 50 includes a payment identifier 51 and a payment authority attribute 54.

The payment identifier 51 includes an inherent ID 52 of the payment authority requesting terminal 30 and an inherent ID 53 of the payment authority holding terminal 40. The payment authority attribute 54 includes a payment period 55, a payment limit 56, a payment region 57, a payment time 58, and an encoded security element 59 for near field payment.

Based on the payment authority information 50, the payment authority holding terminal 40 may determine the authority associated with the payment authority requesting terminal 30.

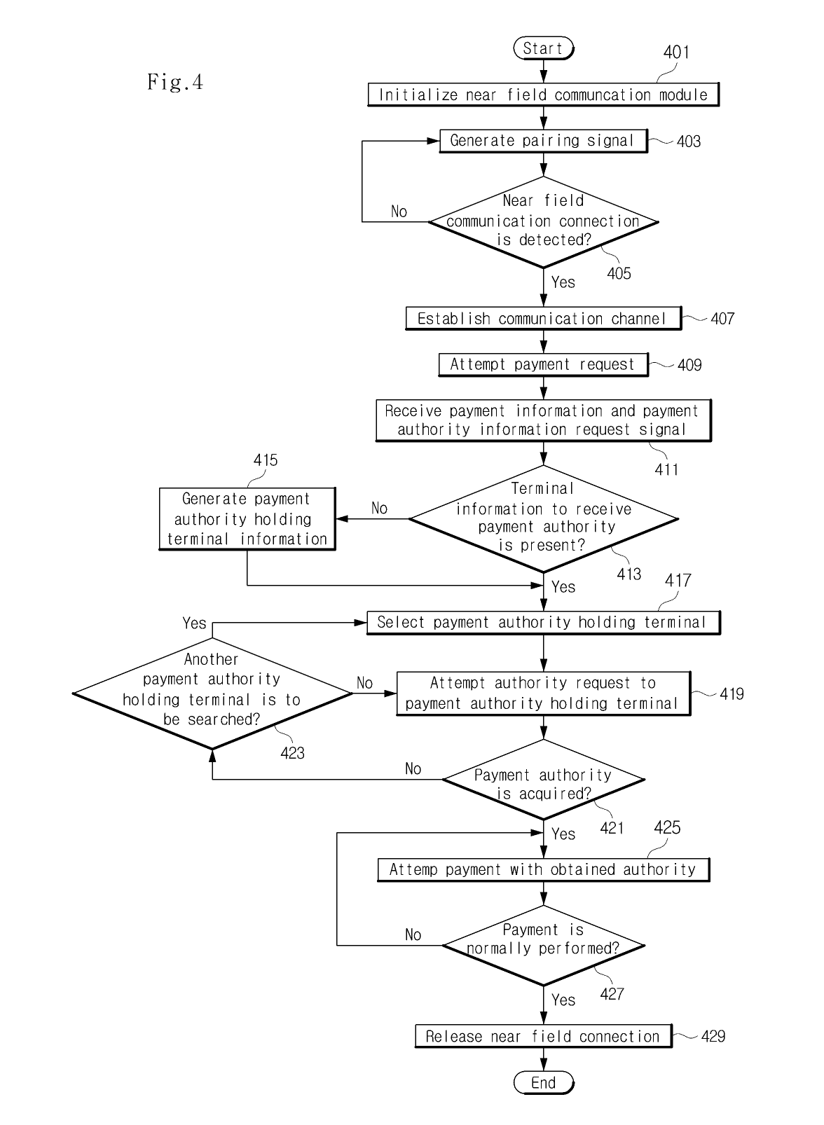

FIG. 4 is a flowchart for illustrating a method for authorizing payment according to an exemplary embodiment of the present invention. FIG. 4 may be performed by the system of FIG. 1, but is not limited as such.

A payment authority requesting terminal 30 and the payment terminal 20 initialize their respective NFC modules (401), and generate a pairing signal (403). A pairing signal may is allow various NFC-capable terminals to establish communication and contact with each other.

A determination is made whether a NFC connection is established between the payment terminal 20 and the payment authority requesting terminal 30 (405).

If not established, a pairing signal is generated once again (403). In the case where the NFC connection is detected, a communication channel between the terminals is established (407). The payment authority requesting terminal 30 may attempt a payment request to the payment terminal 20 (409). For example, a user operating the payment authority requesting terminal 30 may request to transfer a sum of funds to a station or a user maintaining or receiving a service from the payment terminal 20.

The payment terminal 20 transmits information about the payment and a payment authority information request signal to the payment authority requesting terminal 30 in response to the request from the payment authority requesting terminal 30, and the payment authority requesting terminal 30 receives the information about the payment and the payment authority information request signal (411).

If the payment authority requesting terminal 30 does not contain the proper authority to make the payment, a determination is made whether the payment authority requesting terminal 30 has information of a payment authority holding terminal 40 to provide authorization. (413). If no, the payment authority requesting terminal 30 generates information which will be used to find or request an appropriate payment authority holding terminal 40. (415). This information is used to select a payment authority holding terminal 40 (417). If the payment authority requesting terminal 30 has information of a payment authority holding terminal 40 to provide authorization in operation 413, the payment authority holding terminal 40 corresponding to the information is selected (417).

If a payment authority holding terminal 40 is selected, a request for an authority is made to the payment authority holding terminal 40 (419). The retrieved authority may be communicated to the payment authority requesting terminal 30.

The payment authority requesting terminal 30 determines whether the payment authority is acquired or proper (421). If the payment authority is not acquired, or the payment authority received is not proper for the pending transaction, the payment authority requesting terminal 30 searches for another payment authority holding terminal 40 (423). Or, a request for authority may be attempted again to the original payment authority holding terminal 40 (419). If another payment authority holding terminal 40 is searched for, a payment authority holding terminal 40 may be selected (417), and operations 417 and 419 may be repeated.

If the payment authority is acquired from either any of the above techniques, the payment authority requesting terminal 30 may attempt payment via NFC with the acquired authority (425). A determination may be made whether the payment or transaction was successful (427). If not, the payment authority requesting terminal 30 may re-attempt the payment via NFC (425).

If it is determined that the payment is normally performed in operation 427, the near field communication connection is released (429).

In the above example, the payment authority requesting terminal 30 was io authorized to make a payment, as long as it contained a proper authority (such as the one retrieved from the payment authority holding terminal). Thus, an intervening communication to a payment server was not performed.

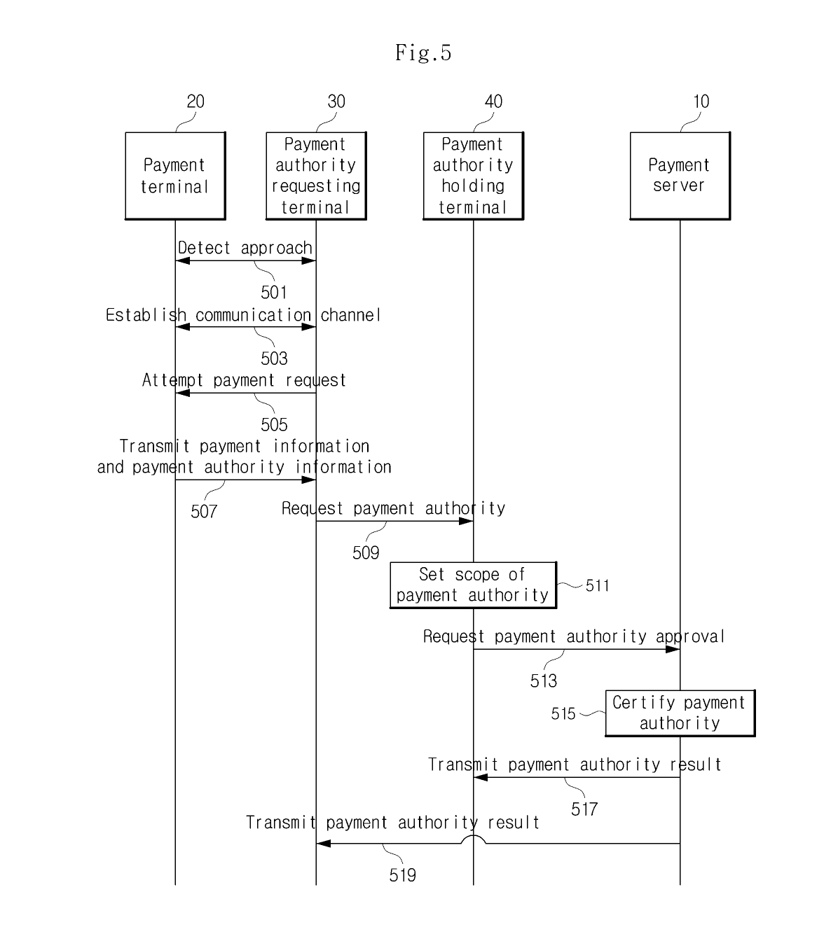

FIG. 5 is a flowchart for illustrating a method for authorizing payment with a payment authority holding terminal according to an exemplary embodiment of the present invention. FIG. 5 may be performed by the system of FIG. 1, but is not limited as such.

If the payment authority requesting terminal 30 is near the payment terminal 20, the proximity between the two terminals may be determined may be determined or detected (501). Due to the proximity, a NFC channel is established between the payment terminal 20 and the payment authority requesting terminal 30 (503).

If the communication channel is established, the payment authority requesting terminal 30 may send a payment request to the payment terminal 20 via NFC (505). The payment terminal 20 receives the request, retrieves information about the payment, such as the price or discount of an item to be purchased, encodes this information, and transmits the information to the payment authority requesting terminal 30 via NFC (507). At this time, the payment terminal 20 may transmit the payment information and a payment authority information request signal simultaneously (507).

The payment authority requesting terminal 30 receives the transmission from the payment terminal 20. The payment authority requesting terminal 30 may determine whether a payment authority is required. If so, the payment authority terminal 30 may send a request to a payment authority holding terminal 40 via a communication network (509). The communication network may be any such communication network, such as an internet connection, wifi connection, a local area network (LAN) or the like.

The payment authority holding terminal 40 remotely receives the information, and sets detailed attributes about whether to permit the payment authority requesting terminal 30 to have and receive the payment authority to make the payment to the payment terminal 20 (511).

If a determination is made in the affirmative, the payment authority holding terminal 40 transmits an approval request for the allowance of payment authority to the payment is server 10 (513). The payment server 10 verifies the request for payment authority allowance, and based on the verification, may certify the payment authority requesting terminal 30 to make payments (515). This certification may be transmitted to the payment authority holding terminal 40, and the payment authority requesting terminal 30 (517, 519).

Thus, the payment authority requesting terminal 30 may now be allowed to conduct transactions and pay a payment terminal 20. As illustrated in FIG. 5, certification and allowance of payment may be accomplished with a combination of NFC and another communication technique. Thus, authority may be given in real time or in a relatively short period of time.

For example, in the case where a parent is an owner of the payment authority holding terminal 40 and children are owners of the payment authority requesting terminals 30, the parent may determine if the children should be granted authority to make a payment, and certify the payment server 10 based on this granting in advance. After that, when the children attempt payment to the payment terminal 20 with the payment authority requesting terminal 30, the payment terminal 20 may perform or deny the payment according to the payment authority certified in the payment server 10 as a response to the payment request of the payment authority requesting terminal 30.

Thus, the payment authority may be granted in real time or may be granted in io advance by the payment authority holding terminal 40 before the payment authority requesting terminal 30 requests payment.

If the payment authority is granted to the payment authority requesting terminal 30 as described above, the payment authority requesting terminal 30 may perform payment based on the granted authority.

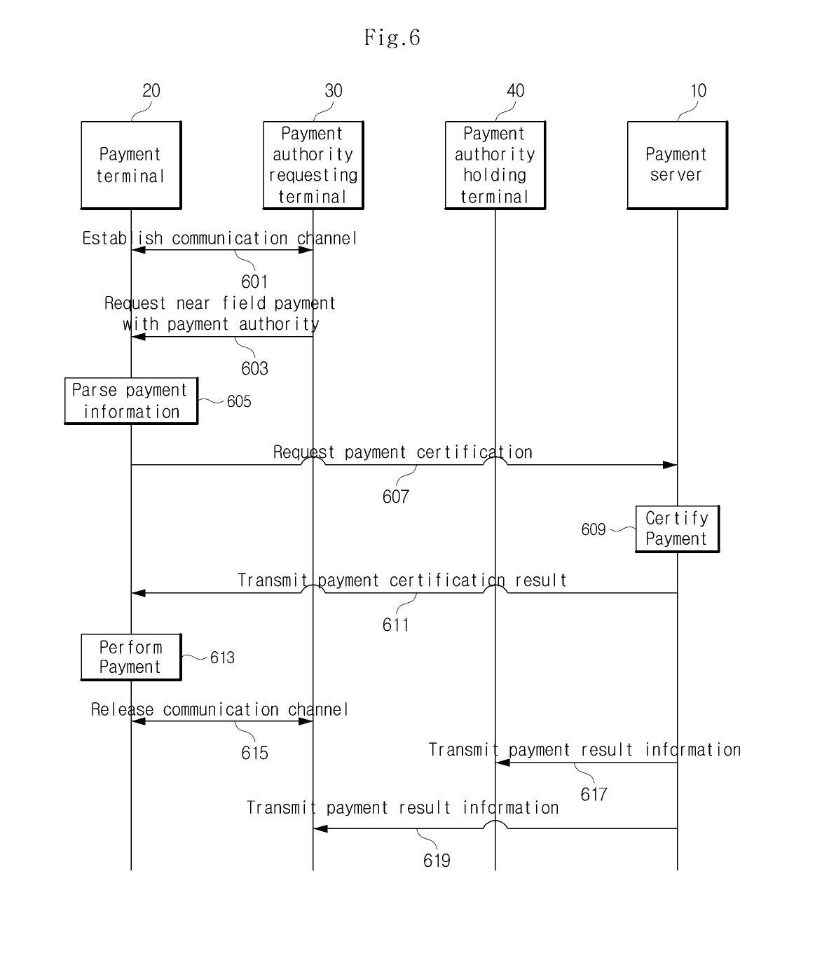

FIG. 6 is a flowchart for illustrating a method for providing results of a payment according to an exemplary embodiment of the present invention. FIG. 6 may be performed by the system of FIG. 1, but is not limited as such.

The payment authority requesting terminal 30 establishes a communication channel with the payment terminal 20 (601), and requests payment to be made over NFC (603). In the example shown in FIG. 6, the payment authority requesting terminal 30 has permission to make a payment (or has received it using the operations shown in FIG. 4 or FIG. 5).

The payment terminal 20 parses the payment from the payment authority requesting terminal 30, and the payment may include the payment item information, the user information, or the like (605), and requests payment approval from the payment server 10 (607).

The payment server 10 certifies that payment is allowed (609), and transmits the payment certification result to the payment terminal 20 (611). As shown in FIG. 5, the allowance of this transaction, or this relationship, may have been set up by a payment authority holding terminal 40.

The payment terminal 20 receives the payment certification result, processes the payment according to the result (613), and releases the communication channel with the payment authority requesting terminal 30 (615).

If the payment is completed in this way, the payment server 10 may transmits the results to the payment authority holding terminal 40 and the payment authority requesting terminal 30 (617, 619).

In this way, a user who originally did not have a payment authority may acquire payment authority in real time. In addition, the granted payment authority may serve to limit the authority based on time, specific mobile terminals, or the like.

The disclosure above may be applied to the following fields. The list of fields below are not meant to the limit the application, and merely provided as examples of implementation.

(1) Remote payment based on the agreement of a parent with a youth without authority to perform payment:

In a case where a youth purchases a product such as a cellular phone, a parent may be requested to give authority, the parent may give authority remotely so that the youth may purchase the product.

(2) Multiple authority approving terminals:

A terminal requesting authority may be one of a plurality of authority approving terminals. For example, if an employee of a company attempts a payment for settling disbursements (during a business trip or on an outside duty), it may be possible to allow that specific employee authority for a duration, such as the duration of the trip or for purposes related to the business. For example, if the employee makes a payment for a business purpose, the company may determine in real time if the payment is business related, and authorize the payment.

In another example, if a cosmetic company distributes coupon-type gift certificates for advertising and promoting new products, relevant data may be collected after a io payment via NFC in addition to the usage of the coupon. Thus, a server may be contacted along with the coupon to authorize the NFC payment.

(3) Integrated remote payment:

A payment requesting terminal may receive digital rights management (DRM) authority from a plurality of authority holding terminals each associated with a social networking is service (SNS). The communication server may collect DRM and payment authorities of the payment requesting terminal, and transmit the collected information to the authority requesting terminal so that it may collect authority from the multiple authority holding terminals to perform payment.

(4) Public funds and payment system:

An authority may be generated for the drawing of public funds, and the authority may be requested whenever a grouping of multiple users may request the authority. Thus, one authority may be commonly used by several persons.

For example, in the case where several employees of a company working overtime have to pay for a taxi fee remotely, a group of employees may use one authorization for payment.

(5) Managing cash flow:

If cash disbursements occur due to business activities, the actual purchase or procurement activity may be performed after obtaining approval through various systems integrated by a company, such as Enterprise Resource Planning (ERP) and Maintenance Repair Operations (MRO), or the cash disbursements are managed manually. However, according to this disclosure, cash disbursements occurring due to purchase, procurement or sales activity in linkage with a system such as ERP or MRO, may be controlled in real time so that the payment is approved or denied, thereby allowing for the control of cash flow. As the process to purchase or procure an item becomes more streamlined, as facilitated by this disclosure, the process may allow a businessperson to more efficiently make decisions.

Furthermore, cash flow, short-term debt or the like occurring in business such as purchase, procurement and sales activities may be actively controlled.

(6) Transfers of a card specific authority:

The authority associated with a card having specific authority may be transferred to another user. In other words, in the case where a specific card gives the users discounts at a department store or restaurant, it is possible to perform payment by using the card with the discount. Since NFC allows reading or writing data, service points may be accumulated if payment is performed at a coffee bar or the like. Thus, if one user uses the card, he or she may obtain authority to use the card from the actual owner of the card.

Additionally, if a card has reward points, the use of several cards may be associated together, therefore allowing a group of users to use the cards.

(7) Expansion to other systems not associated with payment:

The disclosed aspects herein may be utilized for other activities, such as receiving permission or authorization to enter a system requiring security. Thus, a terminal may attempt to access a security station via NFC, and obtain authorization via a communication network.

In another example, if authority for specific DRM data is acquired from an authority holding terminal, a terminal holding the DRM data may allow a terminal requesting the DRM data authority to use the DRM to obtain desired files or media.

In another example, if a user other than a server manager accesses the server via NFC, a text message (e.g. SMS) or multimedia message (e.g. MMS) may be transmitted to the server manager, and the server manager may allow the corresponding user to access the server.

In addition, since the certification and security procedure is performed through the payment server, the communication network, and the near field communication, it is possible to prevent payment from being performed without authority and prevent payment information from leaking, thereby providing a security feature.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A terminal, comprising:
a communication unit to communicate via a payment server;
a short range communication unit to communicate via short range communication to a second terminal; and
a processor to parse data for either communication via the network or short range communication.

2. The terminal of claim 1, wherein in response to the terminal and the second terminal being within a threshold distance from each other, the short range communication unit communicates data to the second terminal, and if the terminal is unrecognized by the second terminal, the communication unit communicates certification via the payment server.

3. The terminal according to claim 1, wherein the short range communication unit communicates with near field communication (NFC).

4. The terminal according to claim 1, wherein the short range communication unit communicates with radio frequency identification (RFID).

5. The terminal according to claim 3, wherein processor parses the data as either a request or a payment.

6. The terminal according to claim 5, wherein the request is a request for the certification communicated via the communication unit to an authority holding terminal, and
after the authority holding terminal certifies the terminal, the short range communication unit communicates the payment.

7. The terminal according to claim 5, wherein the request is a request for certification communicated to a server, and
after receiving confirmation from the server, the short range communication unit receives the payment from the second terminal.

8. The terminal according to claim 6, wherein the authority holding terminal certifies the payment by adding a restriction to the payment according to one of: a specific ID of the terminal, a payment period, payment limit, payment region, or payment time.

9. The terminal according to claim 6, wherein the terminal receives a result of the payment via the communication unit, after short range communication has been disconnected.

10. A method for authorizing a terminal, comprising:
establishing short range communication from the terminal to a second terminal in response to the terminal and the second terminal being within a threshold distance from each other;
parsing data to be communicated via short range communication or via the network; and
if the terminal is unrecognized by the second terminal, communicating a certification via the network.

11. The method according to claim 10, wherein the short range communication is near field communication (NFC).

12. The method according to claim 10, wherein the short range communication is radio frequency identification (RFID).

13. The method according to claim 11, wherein the data is parsed as either a request or a payment.

14. The method according to claim 13, wherein the request is a request for the certification communicated via the network, and
after the terminal is certified, the terminal communicates the payment via short range communication.

15. The method according to claim 13, wherein the request is a request for certification communicated to a server, and
after receiving confirmation from the server, the terminal accepts the payment via short range communication.

16. The method according to claim 14, wherein the certification restricts the payment by one of the following parameters: a specific ID of the terminal, a payment period, payment limit, payment region, or payment time.

17. The method according to claim 14, further comprising:
disconnecting the short range communication; and
receiving a result of the payment via the network.

18. A system to authorize a payment using a communication technique, comprising:
a payment authority requesting terminal to request a payment authority using the communication technique;
a payment terminal to receive the payment authority request and payment authority information;
a payment holding authority terminal corresponding to the payment authority information to provide an authority for the payment; and
a server to receive the authority for the payment and to authorize the payment terminal to accept the payment from the payment authority requesting terminal.

19. The system according to claim 18, wherein the communication technique is near field communication (NFC).

20. The system according to claim 19, wherein the payment holding authority terminal communicates the authority via a network.

21. The system according to claim 18, wherein the communication technique is RFID.

22. A payment authority requesting terminal, comprising:
a wireless communication unit to communicate via a payment server;
a near field communication unit to communicate via short range communication to a second terminal;
a payment authority management layer to determine whether to use an internal payment authority or to generate a request for payment; and
a processor to parse data for either communication via the network or short range communication,
wherein, in response to the terminal and the second terminal being within a threshold distance from each other, the near field communication unit communicates the request for payment to the second terminal.

23. A payment authority holding terminal, comprising:
a wireless communication unit to communicate via a payment server;
a near field communication unit to communicate via short range communication; and
a payment authority management layer to generate payment authority according to s authority information; and
a processor to parse data for either communication via the payment server or short range communication,
wherein, in response to receiving a payment request, the payment authority management layer generates payment authority and the wireless communication unit transmits the payment authority to the payment server, and the payment sever approves the payment request to a second ii terminal according to the payment authority.
